(19) United States
(12) Patent Application Publication
(10) Pub. No.: US 2004/0010953 A1
(43) Pub. Date: Jan. 22, 2004

(54) Tri-foldable card

(76) Inventors: Ronald C. Chimenti, DePere, WI (US); Mark S. Rhea, Green Bay, WI (US)

Correspondence Address: QUARLES & BRADY LLP, 411 E. WISCONSIN AVENUE, SUITE 2040, MILWAUKEE, WI, 53202-4497, US

(21) Appl. No.: 10/616,780

(22) Filed: Jul. 10, 2003

Related U.S. Application Data
(60) Provisional application No. 60/395,095, filed on Jul. 10, 2002.

(51) Int. Cl. G09F 3/18; G09F 3/00

(52) U.S. Cl. 40/661.08; 40/323

(57) ABSTRACT

A tri-foldable card is provided having a first panel that defines first and second opposed lateral edges. A second panel and third panel are also provided, each having inner lateral edges. A first hinge joins the first lateral edge of the first panel to the lateral edge of the second panel. A second hinge joins the second lateral edge to the lateral edge of the third panel. The second hinge has a thickness greater than the first hinge such that the second panel is foldable about the first hinge to close the second panel, and the third panel is foldable about the second hinge to close the third panel after the second panel has been closed. A medallion can be contained in a housing that extends through one of the panels.

### CROSS-REFERENCE TO RELATED APPLICATIONS

The present application claims priority to U.S. Patent application No. 60/395,095, filed on Jul. 10, 2002 and entitled “Tri-foldable Card” the disclosure of which is hereby incorporated by reference as if set forth in its entirety herein.

### STATEMENT REGARDING FEDERALLY SPONSORED RESEARCH OR DEVELOPMENT

Not Applicable.

### BACKGROUND OF THE INVENTION

The present invention relates generally to coin holders and the like and, in particular, relates to a display card having an insert for the storage of medallions and other mementos.

Many people collect various mementos and other items, such as medallions, for the commemoration of historical and other significant events. It has become desirable for the manufacturer of such mementos to produce medallions and to market them to the consumer in such a manner that prominently displays and protects the item while providing space to print a description and artwork identifying the item's historical significance. It had thus been typical to produce a single non-foldable card having an aperture extending therethrough in which a medallion was mounted within a clear protective shield to enable the consumer to view and handle the item while minimizing the risk of damage. The front and rear faces of the card further provided adequate space for the manufacturer to insert text and other designs to augment the memento. The simple design of the card along with its small size enables enhanced portability without sacrificing the significance of the memento.

One such historical event worthy of such a memento occurred on Sep. 11, 2001, inspiring heroism and a renewed sense of nationalism throughout the United States. During the attack, a large number of firefighters gave selflessly of themselves, thereby generating a renewed sense of gratitude to the New York City fire department, and respect to all firefighters nationwide for the risks they undertake on a daily basis. It has therefore become desirable to produce a memento in honor of those who gave of themselves on September 11, and to individually identify the firefighters that lost their lives. However, conventional cards do not provide an adequate amount of space to insert a commemorative medallion along with text that pays a proper tribute to the firefighters. The commemoration of other historical events and the like may also require more space than is currently available on conventional cards.

For instance, referring to FIG. 1, a unitary card includes a first sheet of enamel having printing and/or graphics disposed on an outer surface, while the inner surface is bonded to one surface of a sheet of cardboard to provide structure for the card. A second sheet of enamel is provided having printing and/or graphics disposed on an outer surface, while the inner surface is bonded to the other surface of the sheet of cardboard. The exposed enamel surfaces are laminated. A housing extends through the card and contains a medallion. In particular, the housing extends a greater distance outwardly from one surface of the card than the other to provide stability to the card when resting on a flat surface. The medallion consumes valuable space, however, and accordingly only the remaining portions of the front and back of the card are available to receive text and graphics.

It is therefore desirable to provide a card that has increased space over conventional cards to allow the insertion of a commemorating medallion along with more textual information and graphic design than previously achieved without adversely affecting the size and portability of the card.

### SUMMARY OF THE INVENTION

In one aspect of the invention a card is provided having a first panel that defines first and second opposed lateral edges. A second panel and third panel are also provided, each having inner lateral edges. A first hinge joins the first lateral edge of the first panel to the lateral edge of the second panel. A second hinge joins the second lateral edge to the lateral edge of the third panel. The second hinge has a thickness greater than the first hinge such that the second panel is foldable about the first hinge to close the second panel, and the third panel is foldable about the second hinge to close the third panel after the second panel has been closed.

These and other aspects of the invention are not intended to define the scope of the invention for which purpose claims are provided. In the following description, reference is made to the accompanying drawings, which form a part hereof, and in which there is shown by way of illustration, and not limitation, a preferred embodiment of the invention. Such embodiment does not define the scope of the invention and reference must be made therefore to the claims for this purpose.

### BRIEF DESCRIPTION OF THE FIGURES

FIG. 1 is a perspective view of a conventional unitary card;

FIG. 2 is a perspective view of a tri-foldable card constructed in accordance with a preferred embodiment of the invention in a folded configuration such that a rear face of the middle panel is visible;

FIG. 3 is a side elevation view of the card illustrated in FIG. 2 in an unfolded configuration such that the inner faces of the three panels are visible;

FIG. 4 is a sectional side elevation view of the card illustrated in FIG. 3 taken along the line 3-3; and

FIG. 5 is a side elevation view of a card similar to the card illustrated in FIG. 3 but constructed in accordance with an alternate embodiment.

### DESCRIPTION OF THE PREFERRED EMBODIMENT

The present invention includes a tri-foldable card that is suitable to house a medallion commemorating a historical or significant event while providing increased space for text and graphic design. In particular, the card is suitable to provide a medallion in honor of the New York City firefighters who lost their lives on Sep. 11, 2001, while achieving sufficient space to list each individual firefighter along with a caption of the event and graphic design.

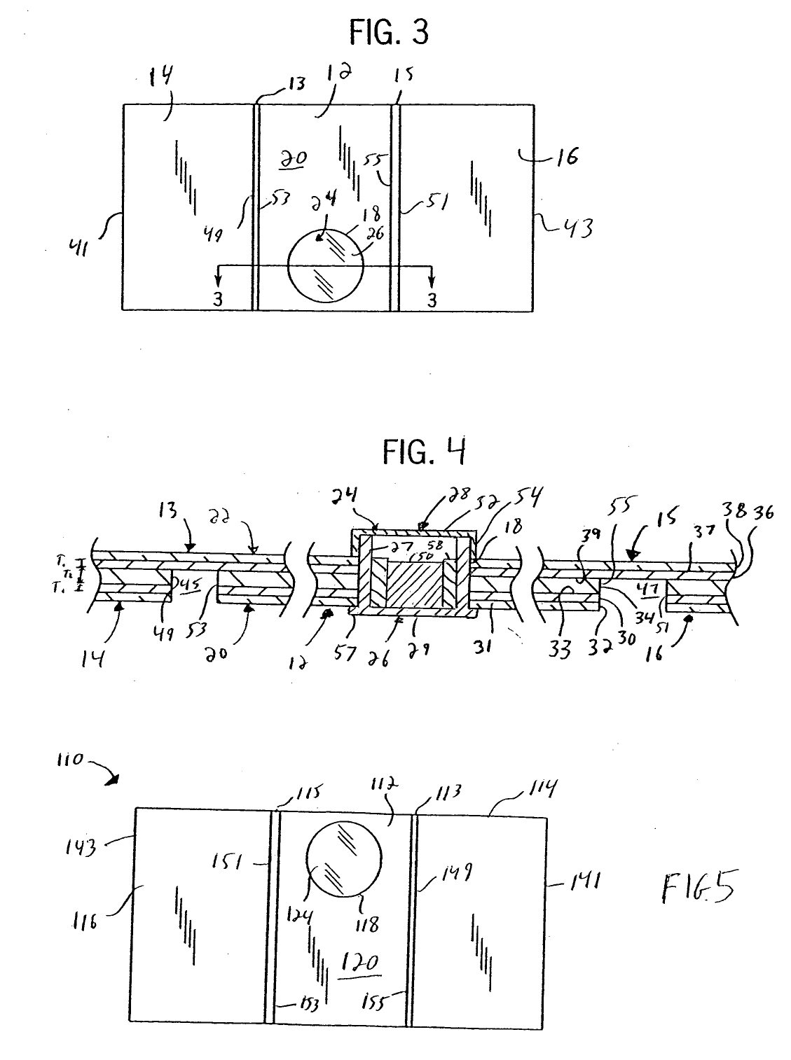

Referring now to FIGS. 2 and 3, the card 10 includes two outer rectangular panels 12 and 16, and a center rectangular panel 14 that collectively present an inner surface 20 closed to the user when the card is folded, and an outer surface 22 that is exposed to the user when the card is folded. Panel 14 defines a left-most panel, and panel 16 defines a right-most panel with respect to the user when the card 10 is open. Outer lateral edges 41 and 43 of panels 14 and 16, respectively, define the lateral outer edges of card 10. Panels 14 and 16 further define inner lateral edges 49 and 51, respectively, that are disposed opposite to outer lateral edges 41 and 43, respectively. Center panel 14 defines opposed lateral edges 53 and 55.

Panels 12 and 16 are connected to panel 14 via hinge sections 13 and 15, respectively, such that lateral edge 49 interfaces with lateral edge 53, and lateral edge 51 interfaces with lateral edge 55. When the card is folded as illustrated in FIG. 2, panel 14 is sandwiched between panels 12 and 16. The card 10 is opened from the folded configuration to the open configuration illustrated in FIG. 3 by first rotating panel 16 outwardly about hinge section 15 as indicated by arrow 17, and by subsequently rotating panel 14 outwardly about hinge section 13 as indicated by arrow 19. The card 10 is folded by first rotating panel 14 about hinge 13 and then by rotating panel 16 about hinge 15.

A generally cylindrical aperture 18 extends through the center panel 14 that receives a housing 24 carrying a memento, such as a medallion 50. Preferably the medallion is encased in a transparent cylindrical housing 24 to provide protection for the medallion without compromising its visibility to the customer. It should be appreciated, however, that the aperture 18 may comprise any size and shape suitable to house other types of mementos. The medallion 50 is visible to the user when the card 10 is closed. As illustrated in FIG. 4, the housing 24 extends slightly outwardly from the inner surface 20 of the center panel 14, and extends slightly more outwardly from the outer surface 22. The low profile between housing 24 and inner surface 20 of center panel eliminates (or at least minimizes) the interference between housing 24 and panel 14 when the card 10 is folded.

Referring now to FIG. 4 in particular, the fabrication of card 10 begins with a first enamel sheet of paper 30 whose inner face 31 includes printed text and graphic design. A layer 32 of lamination is then applied to the inner face 31 of sheet 30, which ultimately provides the inner surface 20 for the card 10. The lamination provides protection for sheet 30 and is transparent to enable unobstructed visibility of the graphics disposed on the inner face 31. A sheet 34 of paper stock, cardboard, or the like is also provided and is adhesively attached to the outer face 33 of sheet 30.

The structure provided by layers 30, 32, and 34 is next die-cut to form the three panels 12, 14, and 16, such that panel 12 and panel 14 are separated by a first void 45, and panels 14 and 16 are separated by a second void 47. In particular, void 47 separates panel 16 from panel 14 a greater distance than the separation between panels 12 and 14 in order to receive the outer edge of panel 14 when the card 10 is closed. Voids 45 and 47 enable the card 10 to be opened and closed about hinges 13 and 15, as will be described in more detail below. It should be appreciated that the text and graphics on the inner face 31 of sheet 30 are preferably arranged to provide designated cut-away sections without losing content from the graphics and text.

A second enamel sheet of paper 36 is provided having an inner face 39 and an outer face 37 opposite the inner face. Additional desired text and graphics are printed on outer face 37. A layer 38 of laminate is then applied to outer face 37 which protects surface 37 while enabling visibility of the associated text and graphics to the user. Layers 37 and 38 provide the outer surface 22 of card 10. Accordingly, the text and graphics disposed on outer face 37 of the portion of sheet 36 providing center panel 14 are visible to the user when the card 10 is in the closed position. The three panels 12, 14, and 16 are then adhesively attached to the inner face of sheet 36 to form hinge sections 13 and 15 defined by the combination of sheet 36 and laminate 38. During operation, voids 45 and 47 provide sufficient clearance for panels 12, 14, and 16 to rotate about hinges 13 and 15. It should thus be appreciated that sheets 30 and 36 have a reduced thickness T1 compared to the thickness T2 of sheet 34. It should further be appreciated that sheets 30, 34, and 36 could be made of any material and have any thickness suitable to provide their desired function.

While layers 30, 34, and 36 are initially the same size prior to fabrication, they are processed during the fabrication process such that hinges 13 and 15 are advantageously of different sizes, thereby producing panels 12, 14, and 16 of different sizes to facilitate the folding and unfolding of the card 10 with minimal or no interference. In particular, the die cut to produce hinge 15 is thicker than the cut used to produce hinge 13. As a result, the outer edge 41 of panel 14 fits into the groove formed by hinge 15 to provide structure to the hinge when the card 10 is folded. The larger hinge 15 is also able to swivel panel 16 about the outer edge 41 when the card is closed and subsequently opened. Panel 16 is cut to be slightly longer in the lateral direction than middle panel 12, while panel 12 is slightly longer in the lateral direction than panel 14.

As described above, a laterally centered cylindrical aperture 18 extends through the lower end of panel 12. Housing 24 includes an inner base member 26 covered by an outer cap 28. Base member 26 includes a cylindrical body 27 that extends through aperture 18, and a cylindrical bottom 29 extending radially across the inner end of body 27. Bottom 29 extends radially beyond body 27 to define a flange 57 that engages inner surface 20 of card 10. Cap 28 includes a cylindrical portion 52 and an annular flange 54 extending outwardly from the radially outer edge of cylindrical portion 52. Flange 54 has an inner diameter that is slightly greater than the outer diameter of body 27 such that the cap 28 may be pressure-fit onto base member 26. The interference between flange 54 and outer surface 22, and flange 29 and inner surface 20, prevents movement of housing 24 through the aperture 18.

Base member 26 and cap 28 thus define an internal cylindrical void 56 that houses cylindrical medallion 50. An annular guard 58 circumscribes the periphery of the void, such that the medallion 50 is surrounded and protected by the guard during use. It should be appreciated that guard 58 may comprise rubber, plastic, foam, or other like compliant material capable of protecting the medallion 50 from damage due to collisions with housing 24.

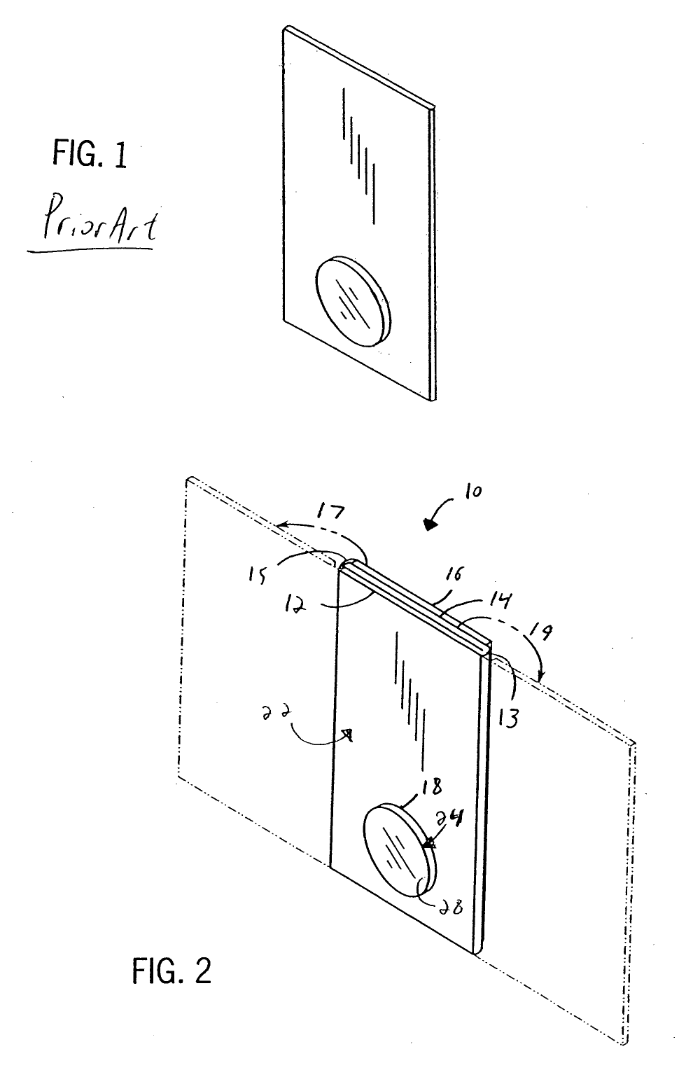

The resulting card 10 presents an increased surface area for receiving text and graphics with respect to unitary cards that have been conventionally produced, and folds easily without detracting from the visibility of the medallion. The card 10 thus provides adequate space to house the medallion and pay a proper tribute to the firefighters who lost their lives on September 11^{th}, though it should be appreciated that the card may include any desired text and graphic design to be used to commemorate other events as well. Advantageously, when card 10 is closed, the card 10 does not occupy significantly more space than the unitary card illustrated in FIG. 1.

Referring now to FIG. 5, a tri-foldable card 110 constructed in accordance with an alternate embodiment of the invention is illustrated having reference numerals corresponding to elements similar to those illustrated in FIGS. 2-4, incremented by 100 for the purposes of clarity and convenience. Card 110 illustrates that the positions of hinge sections 113 and 115 could be reversed with respect to the embodiment illustrated in FIGS. 2-4. Accordingly, the panel 114 is the right-most panel, and panel 116 is the left-most panel (with respect to the user when the card 110 is open). Panel 114 is folded about hinge 113 prior to folding section 116 when the card is to be folded. Furthermore, the position of cylindrical aperture 118 and corresponding housing 124 have been changed with respect to the card 10 illustrated in FIGS. 2-4. While aperture 118 and housing 124 are positioned at the upper end of section 112 of card 110, it should be appreciated that these elements could alternatively be positioned anywhere on any of the three panels 112, 114, and 116 as desired both in the embodiment illustrated in FIG. 5 as well as the embodiment illustrated in FIGS. 2-4.

The invention is not intended to be limited to the specific profile illustrated herein and described above in accordance with the preferred embodiment. Other variations of the invention may be made which fall within the scope of the present invention even though such variations were not specifically discussed herein, as will be understood with reference to the following claims.

We claim:

1. A card that may be opened and closed, comprising:
a first panel having first and second opposed lateral edges;
a second panel having an inner lateral edge;
a third panel having an inner lateral edge;
a first hinge joining the first lateral edge to the inner lateral edge of the second panel;
a second hinge joining the second lateral edge to the inner lateral edge of the third panel;
a transparent housing extending through one of the panels and encasing a memento;
wherein the second hinge has a thickness greater than the first hinge such that the second panel is foldable about the first hinge to close the second panel, and the third panel is foldable about the second hinge to close the third panel after the second panel has been closed.

2. The card as recited in claim 1, wherein the housing extends through an aperture formed in the first panel, wherein the memento is visible to a user when the card is closed.

3. The card as recited in claim 2, wherein the card defines an inner surface and an outer surface that is exposed when the card is closed, and wherein the housing extends outwardly a greater distance from the outer surface than the inner surface.

4. The card as recited in claim 1, wherein the panels are generally rectangular.

5. The card as recited in claim 1, wherein the panels comprise a first laminated sheet and a second laminated sheet mounted to opposed surfaces of a third sheet.

6. The card as recited in claim 5, wherein the first laminated sheet and the third sheet are cut into the three panels, and wherein the second laminated sheet is continuous to form the first and second hinges at locations between the three panels.

7. The card as recited in claim 5, wherein the first and second sheets comprise enamel.

8. The card as recited in claim 1, wherein the second panel defines an outer lateral edge opposed from the inner lateral edge, and wherein the outer lateral edge is disposed proximal the second hinge when the second panel is closed.

9. A method for fabricating a card having an inner and outer surface, the method comprising the steps of:
(A) providing a first and second sheet presenting inner and outer surfaces, respectively, wherein the inner surface of the first sheet defines the inner surface of the card, and wherein the outer surface of the second sheet defines the outer surface of the card;
(C) providing a third sheet presenting first and second opposing surfaces, and bonding the outer surface of the first sheet to the first surface of the third sheet;
(D) cutting the first and third sheet into three sections; and
(E) bonding the second surface of the third sheet to the inner surface of the second sheet to define a pair of hinges disposed between the three sections.

10. The method as recited in claim 10, further comprising placing at least one of text and graphics on the inner surface of the first sheet and the outer surface of the second sheet.

11. The method as recited in claim 11, further comprising laminating the inner surface of the first sheet and the outer surface of the second sheet.

12. The method as recited in claim 10, wherein one of the hinges is thicker than the other hinge.

13. The method as recited in claim 10, further comprising forming an aperture through one of the sections, and inserting a housing into the aperture.

14. The method as recited in claim 13, wherein step (D) provides a center panel and a pair of outer panels.

15. The method as recited in claim 14, wherein the aperture and housing extend through the center panel.

16. The method as recited in claim 15, wherein the center panel defines an inner surface and an outer surface that is exposed when the card is closed, and wherein the housing extends outwardly from the center panel a greater distance from the outer surface than the inner surface.
